(19) United States
(12) Patent Application Publication
(10) Pub. No.: US 2008/0018836 A1
(43) Pub. Date: Jan. 24, 2008

(54) Display Device and Method of Manufacturing the Same

(76) Inventors: Chul Huh, Suwon-si (KR); Sang-hun Lee, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/671,558

(22) Filed: Feb. 6, 2007

(30) Foreign Application Priority Data
Feb. 10, 2006 (KR) 10-2006-0013190

(51) Int. Cl. G02F 1/1335

(52) U.S. Cl. 349/106

(57) ABSTRACT

A display device includes a lattice-shaped light-shielding pattern disposed on a transparent insulating substrate, and a color filter disposed on transparent insulating substrate, wherein the color filter overlaps with an edge portion of the light-shielding pattern. Moreover, a portion of the color filter that overlaps with the edge portion of the light-shielding pattern is rounded, and a portion of the color filter that does not overlap with the edge portion of the light-shielding pattern is planar.

This application claims priority from Korean Patent Application No. 10-2006-0013190 filed on Feb. 10, 2006, the disclosure of which is hereby incorporated by reference herein in its entirety.

### BACKGROUND OF THE INVENTION

1. Technical Field

The present disclosure relates to a method of manufacturing a display device, and more particularly, to a display device that exhibits an improved contrast ratio, high color purity, and low color blurring, and to a method of manufacturing the same.

2. Description of the Related Art

With the development of the information society, the demand for display devices has also increased. As a result, flat panel displays such as such as a liquid crystal displays (LCDs), electroluminescent displays (ELDs), a plasma display panels (PDPs), and so on are being researched, developed and widely used in a variety of application fields.

Also due to the beneficial characteristics of good picture quality, thinness, lightness in weight, and low power consumption of flat panel display devices such as, for example, LCDs or organic electroluminescent displays (OLEDs), these flat panel display devices are being used in a wide variety of applications as substitutes for Braun tubes. For example, a liquid crystal display typically has two substrates provided with a plurality of electrodes, and a liquid crystal layer sandwiched between the substrates. Different Voltages are applied to the electrodes to rearrange liquid crystal molecules in the liquid crystal layer, thereby adjusting the transmittance of light passing through the liquid crystal layer. In an organic electroluminescent display (OELD), for example, desired images are obtained by inducing electrically excited state of photoluminescent organic materials in the liquid crystal layer.

Moreover, various micropatterning processes are typically involved in manufacturing liquid crystal displays and organic electroluminescent (EL) displays. A photolithography technique using a photoresist film is a commonly used patterning process. However, the photolithography technique may he costly due to the need for complex processes. Thus, several efforts have been made to develop alternatives to photolithography techniques. One such alternative to the above-mentioned photolithography technique is an inkjet printing technique.

The inkjet printing technique can be used to form a color filter in a liquid crystal display or an organic light-emitting layer in an organic EL display.

For example, a bank structure capable of retaining ink for a predetermined time is used to perform inkjet printing. However, the formation of the bank structure may require an additional photolithography process, and the compatibility between the ink and the bank structure may affect the planarity of edge portions of ink deposited in wells defined by the bank structure. Furthermore, when a bank structure is formed to a high height during the formation of a color filter of a liquid crystal display, the planarity of an alignment film may be adversely affected, thereby reducing the contrast ratio, and also resulting in a reduction of image quality.

Thus, there is a need for a display device that exhibits an improved contrast ratio, high color purity, and low color blurring and a method for manufacturing the same.

### SUMMARY OF THE INVENTION

The exemplary embodiments of the present invention provide a display device that exhibits an improved contrast ratio, high color purity, and low color blurring.

The exemplary embodiments of the present invention also provide a method of easily manufacturing the display device.

In accordance with an exemplary embodiment of the present invention, a display device is provided. The display device includes a lattice-shaped light-shielding pattern disposed on a transparent insulating substrate and a color filter disposed on the transparent insulating substrate, wherein the color filter overlaps with an edge portion of the light-shielding pattern. Moreover, a portion of the color filter that overlaps with the edge portion of the light-shielding pattern is rounded, and a portion of the color filter that does not overlap with the edge portion of the light-shielding pattern is planar.

In accordance with an exemplary embodiment of the present invention, a method of manufacturing a display device is provided. The method includes coating a photoresist film on a transparent insulating substrate having a light-shielding pattern thereon, illuminating light on a rear surface of the insulating substrate and developing the photoresist film to form a plurality of dummy barrier ribs on the light-shielding pattern, and filling in an opening area defined by the light-shielding pattern and the dummy barrier ribs with ink for forming a color filter.

In accordance with an exemplary embodiment of the present invention, a method of manufacturing a display device is provided. The method includes coating a photoresist film on a transparent insulating substrate having a light-shielding pattern thereon, illuminating light on a rear surface of the insulating substrate and developing the photoresist film to form a plurality of dummy barrier ribs on the light-shielding pattern, filling in an opening area defined by the light-shielding pattern and the dummy barrier ribs with ink for forming a color filter, and illuminating light on a front surface of the insulating substrate and developing the insulating substrate to remove the dummy barrier ribs.

### BRIEF DESCRIPTION OF THE DRAWINGS

Exemplary embodiments of the present invention can be understood in more detail from the following description taken in conjunction with the accompanying drawings in which:

FIG. 1 is an exploded perspective view illustrating a liquid crystal display according to an exemplary embodiment of the present invention;

FIG. 2 is a sectional view illustrating a color Filter panel according to an exemplary embodiment of the present invention;

FIGS. 3 through 10 are sequential sectional views illustrating a method of manufacturing the color filter panel of FIG. 2;

FIG. 11 is a sectional view illustrating a liquid crystal display according to an exemplary embodiment of the present invention;

FIG. 12 is a sectional view illustrating a color filter panel according to an exemplary embodiment of the present invention;

FIGS. 13 and 14 are sequential sectional views illustrating a method of manufacturing the color filter panel of FIG. 12; and

FIG. 15 is a sectional view illustrating a liquid crystal display according to an exemplary embodiment of the present invention.

### DETAILED DESCRIPTION OF THE EXEMPLARY EMBODIMENTS

The present invention may, however, be embodied in many different forms and should not be construed as being limited to the exemplary embodiments set forth herein.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. Like reference numerals refer to like elements throughout the specification.

A method of forming a color filter and a method of manufacturing a display device according to an exemplary embodiment of the present invention will now he described more fully with reference to the accompanying drawings, in which exemplary embodiments of the invention are shown. The color filter forming method will be described together with the display device manufacturing method. The display device will be illustrated in terms of a liquid crystal display, but the exemplary embodiments of the present invention are not limited to the illustrated example. It should be understood that the exemplary embodiments of the present invention can also be applied to formation of a color filter for an organic electroluminescent (EL) display, a field emission display, or a plasma display panel.

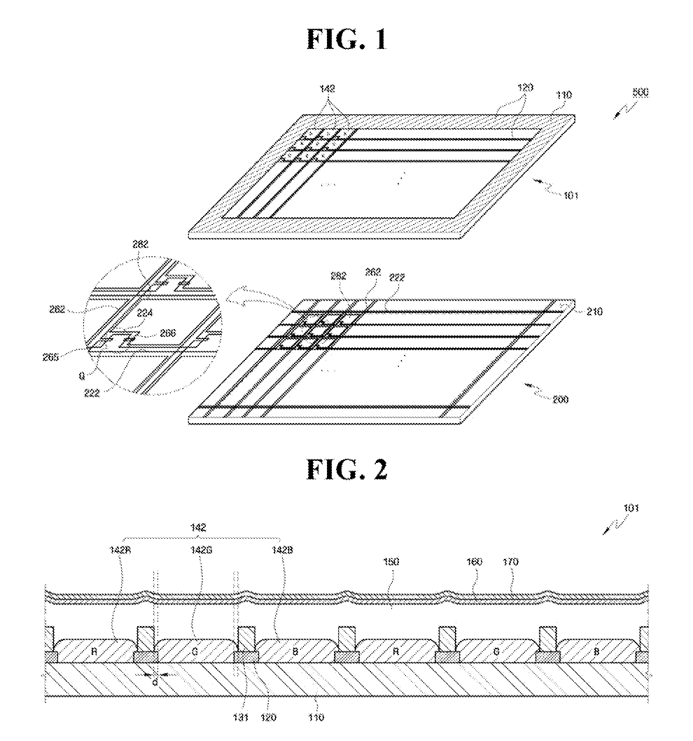

FIG. 1 is an exploded perspective view illustrating a liquid crystal display according to an exemplary embodiment of the present invention.

Referring to FIG. 1, a liquid crystal display 500 includes a color filter pane) 101, a thin film transistor (TFT) array panel 200 facing the color filter panel 101, and a liquid crystal layer interposed between the color filter panel 101 and the TFT array panel 200.

The color filter panel 101 includes a first insulating substrate 110 as a base substrate, light-shielding patterns 120 formed in a lattice shape on the first insulating substrate, and a matrix-shaped color filter 142 surrounded by the light-shielding patterns 120. For example, the color filler 142 may include a red color Filter element R, a green color filter element G, and a blue color filter element B alternately arranged, and may be disposed corresponding to pixel electrodes 182 of the TFT array panel 101. Each color filter element of the color filter 142 is surrounded by the light-shielding patterns 120. The light-shielding patterns 120 are arranged along the boundaries of pixels in such a way as to overlap with gate lines 222 and data lines 262 of the TFT array panel 200.

The TFT array panel 200 includes a second insulating substrate 210 as a base substrate, and a plurality of TFTs Q arranged on the second insulating substrate 210. These TFTs Q are in one-to-one correspondence with matrix-type pixels. Control terminals of the TFTs Q are connected to gate electrodes 224 extending from the gate lines 222 to receive gate signals. Input terminals of the TFTs Q are connected to source electrodes 265 derived from the data lines 262 to receive data signals. Output terminals of the TFTs Q are connected to drain electrodes 266 separated from the source electrodes 265. The drain electrodes 266 are connected to the pixel electrodes 282 constituting pixel regions. When the TFTs Q are turned-on, the drain electrodes 266 receive data signals from the source electrodes 265 and transmit the received data signals to the pixel electrodes 282.

The gate lines 222 connected to the gate electrodes 224 extend in a first direction (e.g., in a row-wise direction) between adjacent ones of the pixel electrodes 282. The data lines 262 connected to the source electrode 265 extend in a second direction (e.g., in a column-wise direction) between adjacent ones of the pixel electrodes 282 and are insulated from the gate lines 222. The TFTs Q are disposed near the intersections of the gate lines 222 and the data lines 262.

After forming the liquid crystal layer between the color filter panel 101 and the TFT array panel 200, the color filter panel 101 and the TFT array panel 200 are sealed by a sealant or sealing member.

Hereinafter, the color filter panel used as one panel of the liquid crystal display described above will be described in more detail with reference to FIG. 2. FIG. 2 is a sectional view illustrating a color filter panel according to an exemplary embodiment of the present invention.

Referring to FIG. 2, a color filter panel 101 includes a first transparent insulating substrate 110 as a base substrate. The first transparent insulating substrate 110 may be a transparent glass substrate, a transparent plastic substrate, or a transparent synthetic resin substrate, but the exemplary embodiments of the present invention are not limited to the illustrated examples.

Light-shielding patterns 120 are disposed on the first transparent insulating substrate 110. The light-shielding patterns 120 serve to block light emitted from a backlight unit and external light. The light-shielding patterns 120 may be made of an organic composition including, for example, a carbon black. When the organic composition further includes a photosensitive material, an etching process can be omitted, which contributes to process simplicity. A material used to form the light-shielding patterns 120 is not limited to the above-illustrated examples. That is, the light-shielding patterns 120 may also be made of an opaque metal such as, for example, chromium, or as a double layer composed of an opaque metal layer and an organic layer. The light-shielding patterns 120 are formed to a predetermined thickness to define an opening area in which color filters are to be formed.

Dummy barrier ribs 131 are disposed on the light-shielding patterns 120. The dummy barrier ribs 131 may be made of photoresist, and preferably, positive-type photoresist.

The widths of the dummy barrier ribs 131 may be smaller than those of the underlying light-shielding patterns 120. In this case, the light-shielding patterns 120 protrude outwardly past the edges of the dummy barrier ribs 131 by a predetermined width d.

The light-shielding patterns 120 and the dummy barrier ribs 131 define an opening area, and red, green, and blue color filter elements 142R, 142G, and 142B of a color filter 142 may be disposed in the opening area. Thus, the color filter 142 may include a resin and red, green, and blue pigments. The resin may be, for example, casein, gelatin, polyvinylalcohol, carboxymethyl acetal, polyimide resin, acryl resin, or melanin resin, but the exemplary embodiments of the present invention are not limited to the illustrated examples.

Major portions of the red, green, and blue color filter elements 142R, 142G, and 142B of the color filter 142 are directly disposed on the first transparent insulating substrate 110. However, as indicated by dotted lines in FIG. 2, edge portions of the red, green, and blue color filter elements 142R, 142G, and 142B of the color filter 142 are disposed on portions of the light-shielding patterns 120 that protrude outwardly past the edges of the dummy barrier ribs 131, and sidewalls of the red, green, and blue color filter elements 142R, 142G, and 142B of the color filter 142 contact sidewalls of the dummy barrier ribs 131. Major portions (including central upper portions) of the red, green, and blue color filter elements 142R, 142G, and 142B of the color filter 142 are planar, but the edge portions of the red, green, and blue color filter elements 142R, 142G, and 142B of the color filter 142 on the protruding portions of the light-shielding patterns 120 are convexly or concavely rounded depending on whether the color filter 142 and the dummy barrier ribs 131 are compatible with each other.

In a case where the dummy barrier ribs 131 and the color filter 142 have poor compatibility, for example, in a case where the dummy barrier ribs 131 are made of a hydrophilic material and the color filter 142 is made of a hydrophobic material, or vice versa, as shown in FIG. 2, the portions of the red, green, and blue color filter elements 142R, 142G, and 142B of the color filter 142 contacting the dummy barrier ribs 131 are positioned to be lower than the central upper portions of the red, green, and blue color filter elements 142R, 142G, and 142B of the color filter 142. Therefore, the edge portions of the red, green, and blue color filter elements 142R, 142G, and 142B of the color filter 142 are convexly rounded. On the other hand, in a case where the dummy barrier ribs 131 and the color filter 142 have good compatibility, for example, in a case where both the dummy barrier ribs 131 and the color filter 142 are made of a hydrophilic material or a hydrophobic material, the portions of the red, green, and blue color filter elements 142R, 142G, and 142B of the color filter 142 contacting the dummy barrier ribs 131 are positioned to be higher than the central upper portions of the red, green, and blue color filter elements 142R, 142G, and 142B of the color filter 142. Therefore, the edge portions of the red, green, and blue color filter elements 142R, 142G, and 142B of the color filter 142 are concavely rounded. The case where the edge portions of the red, green, and blue color filter elements 142R, 142G, and 142B of the color filter 142 are convexly rounded is beneficial because the central upper portions of the red, green, and blue color filter elements 142R, 142G, and 142B of the color filter 142 can be easily made planar, and ink overflow from the dummy barrier ribs 131 during a display manufacturing process can be prevented. In this regard, compatibility between the color filter 142 and the dummy barrier ribs 131 may be lower than compatibility between the color filter 142 and the light-shielding patterns 120.

To accurately control the color purity and blurring phenomenon of the color filter 142 and the arrangement of a liquid crystal layer on the color filter 142, the color filter 142 preferably has a flat surface. To achieve this, the rounded edge portions of the red, green, and blue color filter elements 142R, 142G, and 142B of the color filter 142 may be positioned on the light-shielding patterns 120 that do not contribute to image grayscale presentation of a liquid crystal display. Thus, the light-shielding patterns 120 may protrude outwardly past the edges of the dummy barrier ribs 131 by a sufficient width. For example, the width d by which the light-shielding patterns 120 protrude past the dummy barrier ribs 131 may be about 0.5 μm or more, and more preferably, about 1 μm or more.

An overcoat layer 150 made of a transparent organic material is disposed on the color filter 142 and the dummy barrier ribs 131. The overcoat layer 150 serves to planarize a stepped surface of the underlying structure. Thus, as shown in FIG. 2, the surface planarity of the overcoat layer 150 is higher than that of the color filter 142 and the dummy barrier ribs 131, and portions of the overcoat layer 150 that do not overlap with the light-shielding patterns 120 have better surface planarity.

A common electrode 160 made of a conductive material is disposed on the overcoat layer 150. An alignment, film 170 made of polyimide is disposed on the common electrode 160. In a modification of the current exemplary embodiment of the present invention, a common electrode may be disposed in a TFT array panel. In this case, an alignment film is directly disposed on an overcoat layer.

Hereinafter, a method of manufacturing the color filter panel of a liquid crystal display as described above will be described.

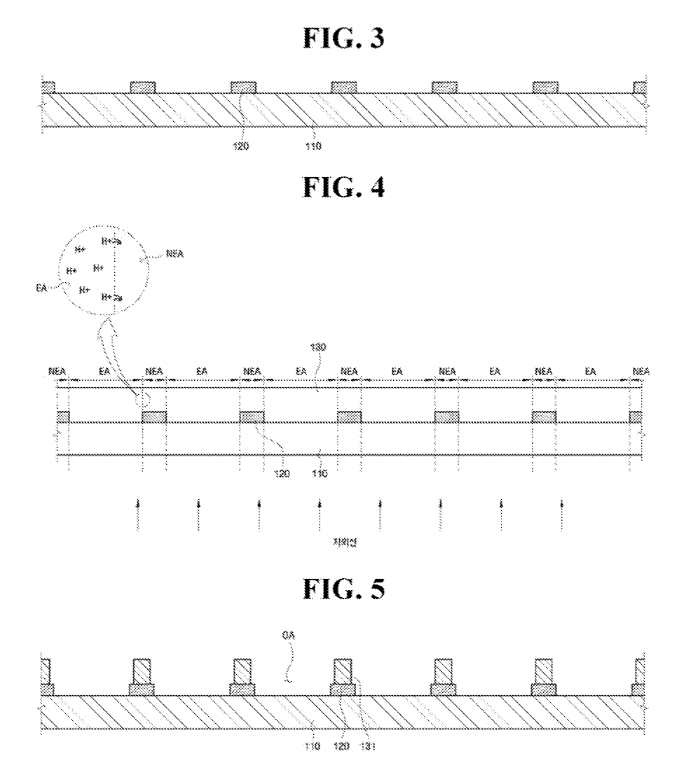

FIGS. 3 through 10 are sequential sectional views illustrating a method of manufacturing the color filter panel of FIG. 2.

Referring to FIG. 3, light-shielding patterns 120 are formed on a first insulating substrate 110 made of, e.g., transparent glass. The light-shielding patterns 120 can be formed using a method commonly known in the art. For example, when the light-shielding patterns 120 are formed using a carbon black or an organic composition including titanium oxide, the carbon black or the organic composition is coated on the first insulating substrate 110 and patterned by photolithography. When the organic composition includes a photosensitive material, the light-shielding patterns 120 can be formed by patterning using exposure and development. When the light-shielding patterns 120 are formed using an opaque metal such as, for example, chromium, the opaque metal is deposited on the first insulating substrate 110 and patterned by photolithography. As an alternative method, intaglio printing using a transfer roller can be used. However, the formation of the light-shielding patterns 120 on the first insulating substrate 110 is not limited by the above-illustrated methods.

Next, referring to FIGS. 3 and 4, a positive-type photoresist film 130 including a photo acid generator (PAG) is coated on the entire surface of the resultant structure of FIG. 3. Then, ultraviolet (UV) light is illuminated on the rear surface of the first insulating substrate 110. As a result, areas EA of the photoresist film 130 that do not overlap with the light-shielding patterns 120 are exposed to UV light, whereas non-exposed areas (NEAs) of the photoresist film 130 that overlap with the light-shielding patterns 120 are not exposed to UV light. At this time, exposed areas (EAs) of the photoresist film 130 generate hydrogen ions due to the photoreaction of PAG. The photoresist film 130 is generally insoluble in a developer, but becomes developer-soluble in the presence of the hydrogen ions. Furthermore, when more hydrogen ions are generated in the EAs of the photoresist film 130, as shown in an enlarged view of FIG. 4, developer-soluble portions of the photoresist film 130 are expanded to predetermined portions of the NEAs.

Next, referring to FIGS. 4 and 5, the resultant structure of FIG. 4 is developed using a developer. As a result, the EAs of the photoresist film 130 are dissolved and removed by the developer. At this time, the developer-soluble portions of the NEAs of the photoresist film 130 are also removed. As a result, dummy barrier ribs 131 having a smaller width than the light-shielding patterns 120 are formed. The dummy barrier ribs 131, together with the light-shielding patterns 120, define an opening area (OA) for receiving ink for a color filter.

The width of the developer-soluble portions of the non-exposed areas NEA of the photoresist film 130 is proportional to the concentration of hydrogen ions generated upon exposure. The concentration of the hydrogen ions generated upon exposure is proportional to exposure sensitivity determined by the characteristics of the photoresist film 130 and the amount of UV energy per unit area of the photoresist film 130. Thus, the concentration of hydrogen ions can be adjusted by adjusting the amount of UV energy per unit area, thereby enabling the width of the dummy barrier ribs 131 to be controlled.

In this regard, as described above with reference to FIG. 2, to increase the distance by which the light-shielding patterns 120 protrude past the dummy barrier ribs 131, the dummy barrier ribs 131 should be formed to a narrower width. For this, it is preferable to increase exposure sensitivity. However, exposure sensitivity is restricted by the characteristics of the photoresist film 130 and exposure equipment, higher exposure sensitivity may incur larger process costs, and excessively high exposure sensitivity may inhibit the formation of the dummy barrier ribs 131. In this regard, exposure sensitivity should be appropriately adjusted.

As shown in FIGS. 4 and 5, the dummy barrier ribs 131 are formed by patterning using back-side exposure and development, thereby increasing process simplicity and cost-effectiveness, as compared with a patterning process using a mask.

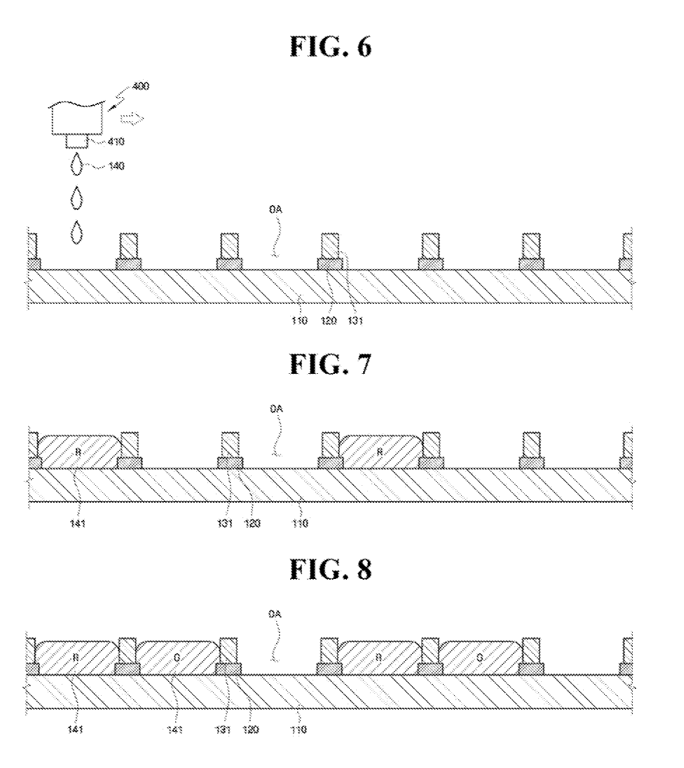

Next, referring to FIGS. 5 and 6, an inkjet printhead 400 including at least one inkjet nozzle 410 is positioned above the resultant structure of FIG. 5.

While moving the inkjet printhead 400 in a predetermined direction, ink 140 for a color filter is sprayed through the nozzle 410. The ink 140 includes a pigment, and may further include a resin and a solvent.

The ink 140 should be filled in the OA so that ink overflow from the dummy barrier ribs 131 does not occur. For this, the height of the dummy barrier ribs 131 can be appropriately adjusted during the formation of the dummy barrier ribs 131 shown in FIG. 5. The amount of the ink 140 sprayed out of the nozzle 410 can be adjusted by adjusting the transport speed, the vibration amplitude, and the vibration frequency of the inkjet printhead 400. For example, the vibration of the inkjet printhead 400 can be controlled by adjusting an applied voltage to the inkjet printhead 400.

The ink 140 is selectively sprayed in the OA according to a desired color filter pattern, as shown in FIG. 7. The spray frequency of the ink 140 can also be controlled by adjusting the applied voltage to the inkjet printhead 400. For example, in a case where the ink 140 is sprayed in a first one of every three openings, as shown in FIG. 7, the inkjet printhead 400, when positioned above a first opening, is vibrated so that the first opening is filled with the ink 140, whereas the inkjet printhead 400, when positioned above second and third openings, is not vibrated. When the inkjet printhead 140 is positioned above a fourth opening, the fourth opening is filled with the ink 140 by vibrating the inkjet printhead 400 Moreover, in a case where an inkjet printhead includes a plurality of nozzles, ink can be sprayed in a plurality of openings at the same time.

As a result, red color ink 141R, as shown in FIG. 7, is filled in a first one of every three openings.

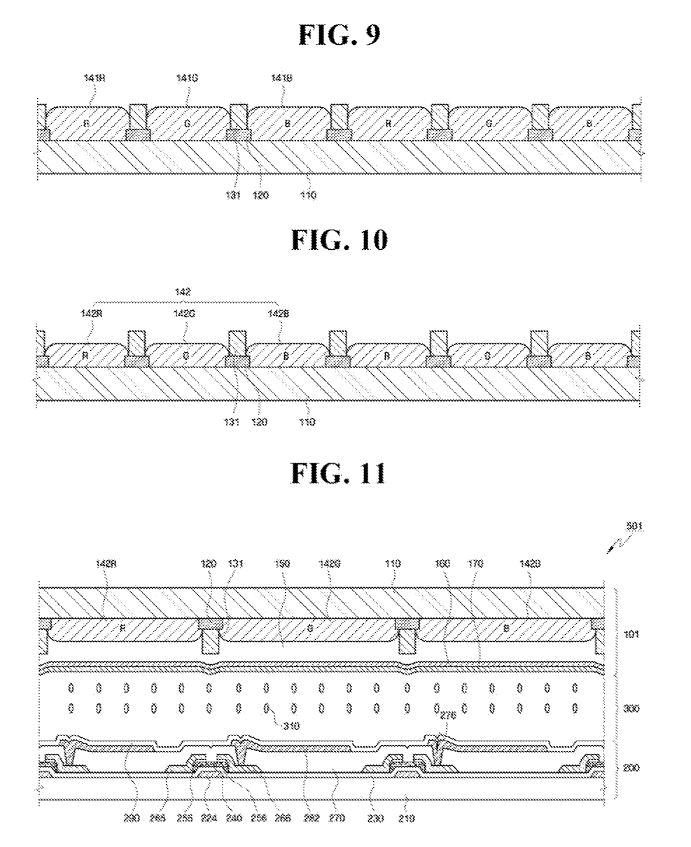

Referring to FIGS. 8 and 9, green color ink 141G and blue color ink 141B are respectively filled in second and third ones of every three openings in a similar way to the above. FIG. 9 illustrates that the red color ink 141R, the green color ink 141G, and the blue color ink 141B are formed to the same thickness. However, the thicknesses of the red color ink 141R, the green color ink 141G, and the blue color ink 141B may be slightly different in terms of color purity adjustment.

Meanwhile, if the dummy barrier ribs 131 are hydrophobic and the red color ink 141R, the green color ink 141G, and the blue color ink 141B filled in the OA are hydrophilic, edge portions of the red color ink 141R, the green color ink 141G, and the blue color ink 141B contacting the dummy barrier ribs 131 are convexly rounded, whereas central upper portions of the red color ink 141R, the green color ink 141G, and the blue color ink 141B have flat surface profiles, as shown in FIGS. 7-9. As the light-shielding patterns 120 disposed below the dummy barrier ribs 131 protrude outwardly past the edges of the dummy barrier ribs 131, portions of the red color ink 141R, the green color ink 141G, and the blue color ink 141B that do not overlap with the light-shielding patterns 120 have flat surfaces (e.g., are less rounded).

Next, referring to FIGS. 9 and 10, the resultant structure of FIG. 9 is dried. The drying may be performed by thermal treatment. During thermal treatment, the heights of the red color ink 141R, the green color ink 141G, and the blue color ink 141B are reduced while a solvent component of the red color ink 141R, the green color ink 141G, and the blue color ink 141B is evaporated, thereby resulting in a solid color filter 142 composed of red, green, and blue color filter elements 142R, 142G, and 1428 including a pigment and a resin. To increase the surface planarity of portions of the red, green, and blue color filter elements 142R, 142G, and 142B that do not overlap with the light-shielding patterns 120, the red, green, and blue color filter elements 142R, 142G, and 142B may be formed to be thicker than the light-shielding patterns 120 so that sidewalls of the red, green, and blue color filter elements 142R, 142G, and 142B contact sidewalls of the dummy barrier ribs 131. Of course, the thickness of the color filter 142 can be controlled by the content of a solvent in the ink 140 and the amount of the ink 140 that is sprayed out of the nozzle 410.

This completes the color filter 142 having better surface planarity at portions of the color filter 142 that do not overlap with the light-shielding patterns 120. According to the above-described color filter formation method, as shown in FIGS. 5 through 9, a color filter is formed by inkjet printing, instead of a photolithography technique requiring complex processes, thereby enhancing process efficiency.

Also, a transparent organic material, a conductive material, and polyimide are sequentially coated on the entire surface of the resultant structure of FIG. 10 to form an overcoat layer, a common electrode, and an alignment film. As a result, a color filter panel (101 of FIG. 2) is completed. As described above with reference to FIG. 2, portions of the overcoat layer, the common electrode, and the alignment film that do not overlap with the light-shielding patterns 120 have an improved surface planarity.

The color filter panel manufactured according to the above-described method can be used as one panel of a liquid crystal display.

Hereinafter, a liquid crystal display according to an exemplary embodiment of the present invention will be described with reference to FIG. 11. FIG. 11 is a sectional view illustrating a liquid crystal display 501 according to an exemplary embodiment of the present invention.

Referring to FIG. 11, the liquid crystal display 501 includes a color filter panel 101, a TFT array panel 200, and a liquid crystal layer 300 interposed between the color filter panel 101 and the TFT array panel 200.

The color filter panel 101 is the same as the color filter panel described above with reference to FIG. 2, and thus, a description thereof is omitted.

The TFT array panel 200 can have one of various structures known in the art. For example, as shown in FIG. 11, a plurality of gate electrodes 224 are disposed on a second insulating substrate 210 and are covered with a gate insulating layer 230. Semiconductor layers 240 are disposed on the gate insulating layer 230 to overlap with the gate electrodes 224. Source electrodes 265 and drain electrodes 266, which are separated from each other, are disposed on the semiconductor layers 240. Ohmic contact layers 255 and 256 are respectively disposed between the source electrodes 265 and the semiconductor layers 240 and between the drain electrodes 266 and the semiconductor layers 240. The ohmic contact layers 255 and 256 are separated from each other to expose the underlying semiconductor layers 240. The source electrodes 265 and the drain electrodes 266 are covered with a passivation layer 270. Contact holes 276 are present in the passivation layer 270 to expose the drain electrodes 266. Pixel electrodes 282 are disposed on the passivation layer 270 and connected to the drain electrodes 266 via the contact holes 276. An alignment film 290 is disposed on the pixel electrodes 282.

The color filter panel 101 and the TFT array panel 200 face each other, and the liquid crystal layer 300 including liquid crystal molecules 310 is interposed between the color filter panel 101 and the TFT array panel 200.

According to the liquid crystal display 501, portions of red, green, and blue color filter elements 142R, 142G, and 142B that do not overlap with light-shielding patterns 120 have a flat surface and a uniform thickness, thereby improving color purity and preventing blurred vision due to color blurring.

Meanwhile, in a case where the liquid crystal display 501 is a normally black mode liquid crystal display and the alignment films 170 and 290 are vertically aligned alignment films, the liquid crystal molecules 310 are arranged vertically with respect to the surfaces of the alignment films 170 and 290 at a voltage-off state, and thus, a liquid crystal panel has a black brightness. At this time, if the alignment films 170 and 290 are not planar, the liquid crystal molecules 310 may not be arranged vertically with respect to the first and second insulating substrates 110 and 210 at a voltage-off stale, and thus, a liquid crystal panel may have an incomplete black brightness, thereby lowering a contrast ratio (C/R). However, according to the liquid crystal display 501 shown in FIG. 11, portions of an overcoat layer 150, a common electrode 160, and the alignment film 170 that do not overlap with the light-shielding patterns 120 have an improved surface planarity, and thus, a liquid crystal panel has a higher black brightness level, thereby increasing the contrast ratio.

Hereinafter, a method of manufacturing the liquid crystal display as shown in FIG. 11 will be described. The method includes providing a color filter panel, providing a TFT array panel, and forming a liquid crystal layer.

The providing of the color filter panel can be performed as described above with reference to FIGS. 2-10, and thus, a description thereof is omitted.

The providing of the TFT array panel can be performed by one of various methods known in the art. For example, referring to FIG. 11, first, a conductive material is deposited on a second transparent insulating substrate 210 and patterned to form gate electrodes 224. At this time, gate lines are also formed. Then, silicon nitride is deposited on the resultant structure to form a gate insulating layer 230. Then, amorphous silicon and doped amorphous silicon are sequentially deposited and patterned to form semiconductor layers 240 and doped amorphous silicon patterns. Then, a conductive material is deposited and patterned to form source electrodes 265 and drain electrodes 266 that are separated from each other. At this time, data lines are also formed. Then, portions of the doped amorphous silicon patterns that are exposed through the source electrodes 265 and the drain electrodes 266 are etched to form ohmic contact layers 255 and 256. Then, silicon nitride is deposited to form a passivation layer 270. The passivation layer 270 is then patterned to form contact holes 276 exposing the drain electrodes 266. Then, transparent conductive oxide is deposited and patterned to form pixel electrodes 282. Then, polyimide is coated on the resultant structure to form an alignment film 290. This completes a TFT array panel 200.

In a modification of the current exemplary embodiment of the present invention, a TFT array panel having a different structure from the TFT array panel 200 shown in FIG. 11 may also be used.

With respect to the formation of the liquid crystal layer, referring to FIG. 11, a color filter panel 101 and a TFT array panel 200 are disposed to face each other. Liquid crystal molecules 300 are injected between the color filter panel 101 and the TFT array panel 200 and sealed by a sealant or sealing member to form a liquid crystal layer 300. As an alternative method, the liquid crystal molecules 310 are dispensed to the color filter panel 101 or the TFT array panel 200, and the color filter panel 101 and the TFT array panel 200 are then sealed to form the liquid crystal layer 300. This completes a liquid crystal display 501.

Hereinafter, a color filter panel of a liquid crystal display according to another exemplary embodiment of the present invention will be described. A description of the same constitutional elements as those in FIG. 2 will be either omitted or provided in simpler form.

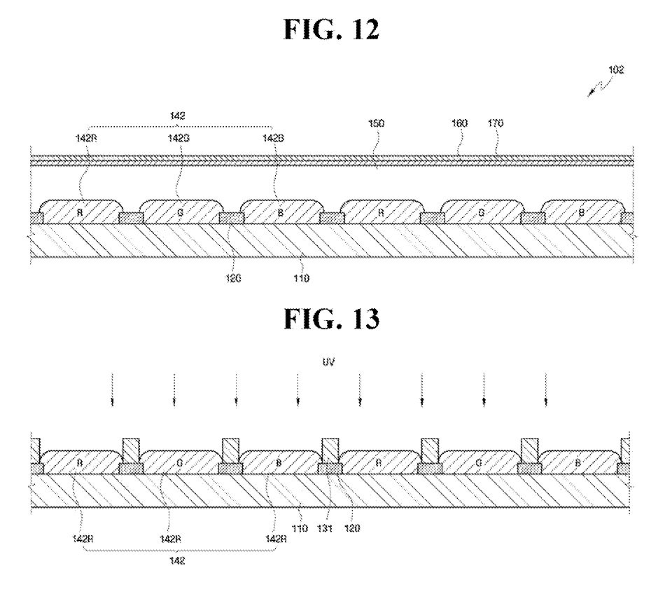

FIG. 12 is a sectional view illustrating a color filter panel according to another exemplary embodiment of the present invention.

Referring to FIG. 12, a color filter panel 102 includes no dummy barrier ribs on light-shielding patterns 102, unlike the color filter panel according to the exemplary embodiment shown in FIG. 2. Furthermore, a lower surface of an overcoat layer 150 covering the light-shielding patterns 120 and a color filter 142 is less stepped, and thus, the overcoat layer 150 has an improved surface planarity. Thus, portions of red, green, and blue color filter elements 142R, 142G, and 142B of the color filter 142 that do not overlap with the light-shielding patterns 120 also have an improved surface planarity.

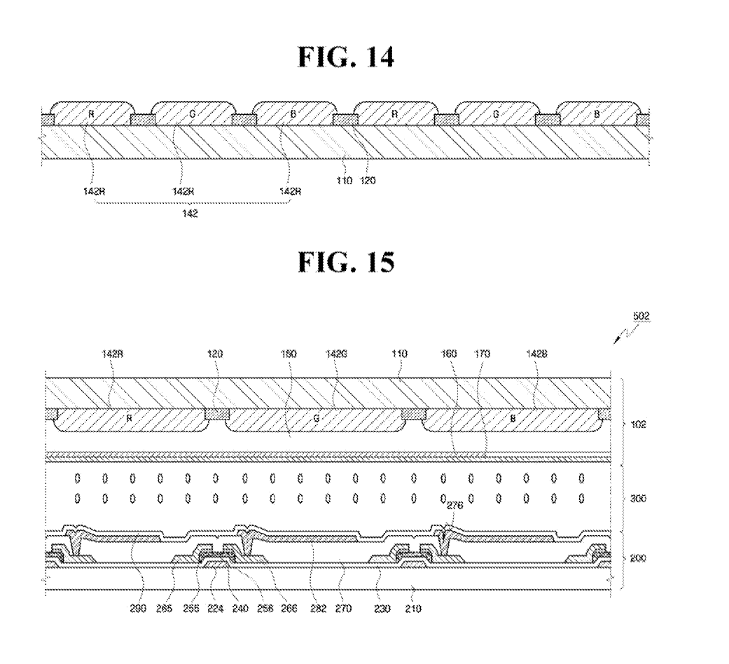

Hereinafter, a method of manufacturing the above-described color filter panel will be described. FIGS. 13 and 14 are sequential sectional views illustrating a method of manufacturing the color filter panel of FIG. 12.

In the manufacturing of the color filter panel according to the exemplary embodiment shown in FIG. 12, a color filter is first completed as shown in FIGS. 3 through 10.

Next referring to FIG. 13, UV light, is illuminated on a front surface of a substrate 110 on which a color filter 142 is formed. Upon exposure, dummy barrier ribs 131 made of positive-type photoresist produce hydrogen ions by photoreaction of PAG, and thus, become soluble in a developer.

Next, referring to FIG. 14, the dummy barrier ribs 131 are removed by development using a developer.

In a modification of the current exemplary embodiment of the present invention, the exposure to UV light may be performed not after the process shown in FIG. 10, but after the process shown in FIG. 9. That is, the exposure to UV light may be performed before drying ink for the color filter 142. In this case, as drying can be performed by UV illumination, an additional drying process may be omitted. Furthermore, when a negative-type resin composition is used as ink for the color filter 142, the dummy barrier ribs 131 made of positive-type photoresist are removed by exposure to UV light and development, whereas the negative-type ink remains.

Moreover, a transparent organic material, a conductive material, and polyimide are sequentially coated on the entire surface of the resultant structure of FIG. 14 to form an overcoat layer, a common, electrode, and an alignment film. As a result, a color fitter panel as shown in FIG. 12 is completed. As described above, in the current exemplary embodiment of the present invention, dummy barrier ribs are removed by front-side exposure, thereby leading to an improved surface planarity.

FIG. 15 is a sectional view illustrating a liquid crystal display according to another exemplary embodiment of the present invention. A description of the same constitutional elements as those in FIG. 11 will be either omitted or provided in simplified form.

Referring to FIG. 15, a liquid crystal display 502 has the same structure as the liquid crystal display shown in FIG. 11 except that it includes a color filter panel 102 as shown in FIG. 12. That is, no dummy barrier ribs are present on light-shielding patterns 120. As a lower surface of an overcoat layer 150 covering the light-shielding patterns 120 and a color filter is less stepped, the overcoat layer 150 has better surface planarity. Therefore, portions of red, green, and blue color filter elements 142R, 142G, and 142B of the color filter 142 that do not overlap with the Sight-shielding patterns 120 have a flat surface and a uniform thickness, thereby improving color purity and preventing blurred vision due to color blurring. Furthermore, portions of the overcoat layer 150, a common electrode 160, and an alignment film 170 that do not overlap with the light-shielding patterns 120 have an improved surface planarity, thereby leading to an improved contrast ratio.

The manufacturing of the liquid crystal display 502 can be easily performed with reference to FIGS. 12-14 and FIG. 11, and thus, a detailed description thereof is omitted.

Hereinafter, exemplary embodiments of the present invention will be described more specifically with reference to the following experimental examples.

### EXPERIMENTAL EXAMPLE

Resin BM (Cheil Industries Inc.) was coated on transparent glass substrates with dimensions of about 730 mm wide, about 920 mm long, and about 0.7 mm thick (1737 glass, Corning), followed by exposure and development, to form about 15.0″ XGA light-shielding patterns. The light-shielding patterns had a thickness of about 15 μm.

Next positive-type photoresist films (HKT601, Clariant) were formed to a thickness of about 3.0 μm on the glass substrates, and dried.

Next, UV light was illuminated on the rear surfaces of the glass substrates using a UV exposure machine (CT-2000PPM, Cleantech) including a low-pressure mercury lamp with an effective wavelength of about 254 nm. At this time, the amount of UV energy per unit area of the glass substrates was about 500 mJ.

Next, the photoresist films were developed using about 0.67% potassium hydroxide (KOH) aqueous solution to form dummy barrier ribs on the light-shielding patterns.

Next, RGB inks (Donjin Semichem Co., Ltd.) for a RGB color filter were sprayed in openings defined by the light-shielding patterns and the dummy barrier ribs using an inkjet sprayer (AKT) to form RGB color filter patterns. At this time, the thickness of the RGB color filter patterns was about 1.9 to about 2.0 μm.

Next, UV light was illuminated on the front surfaces of the resultant structures using a UV exposure machine (CT-2000PPM, Cleantech) including a low-pressure mercury lamp with an effective wavelength of about 254 nm. Then, the dummy barrier ribs were removed by development using a KOH aqueous solution.

Next, the resultant structures were baked at about 230° C. for about 30 minutes.

Then, a transparent overcoat material (JSR) was coated to a thickness of about 1.5 μm on the entire surfaces of the resultant structures, and baked at about 230° C. for about 30 minutes.

Then, indium tin oxide (ITO) was vacuum-deposited on the entire surfaces of the resultant structures using a sputter machine (Ulvac Technologies, Inc.) at about 100° C. At this time, the ITO layer was formed to a thickness of about 1,300 angstroms (Å).

Then, polyimide was coated on the entire surfaces of the resultant structures. As a result, color filter panels were completed.

Next, TFT array panels were manufactured by a known method and were then disposed to face the color filter panels.

Then, liquid crystal molecules were injected between the color filter panels and the TFT array panels, and the color filter panels and the TFT array panels were sealed to thereby complete 15.0″XGA liquid crystal displays.

### COMPARATIVE EXPERIMENTAL EXAMPLES

Liquid crystal displays were manufactured in the same manner as in Experimental Example except that light-shielding patterns were formed to a thickness of about 2.5 μm, no dummy barrier ribs were formed, and front-side exposure to UV light was omitted after forming RGB color filter patterns.

The black brightness and white brightness of the liquid crystal displays manufactured in Experimental Example and Comparative Experimental Example were measured to calculate contrast ratios. Furthermore, microscopic inspection for the color filters of the liquid crystal displays was performed to evaluate the presence or absence of color blurring in the color filters. Visual inspection for the color filters was also performed to evaluate the presence or absence of stain in the color filters. The results are presented in Table 1 below.

TABLE 1

| | Contrast ratio | Color | |
|---|---|---|---|
| Sample | (C/R) | blurring | Stain |
| Experimental Example | 820:1 | X | X |
| Comparative Experimental Example | 270:1 | ◯ | ◯ |

X: absence,
◯: presence

The results of Table 1 demonstrate that a liquid crystal display according to the exemplary embodiments of the present invention shows an improved contrast ratio and has no defects such as color blurring or stain.

As described above, according to display devices of exemplary embodiments of the present invention, a portion of a color filter that does not overlap with a light-shielding pattern has a flat surface and a uniform thickness, thereby improving color purity and contrast ratio and preventing blurred vision due to color blurring. Furthermore, the display devices can be easily manufactured by back-side exposure of a positive-type photoresist coating film.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A display device comprising:
a lattice-shaped light-shielding pattern disposed on a transparent insulating substrate; and
a color filter disposed on the transparent insulating substrate, wherein the color filter overlaps with an edge portion of the light-shielding pattern,
wherein a portion of the color filter that overlaps with the edge portion of the light-shielding pattern is rounded, and a portion of the color filter that does not overlap with the edge portion of the light-shielding pattern is planar.

2. The display device of claim 1, further comprising a plurality of dummy barrier ribs on the light-shielding pattern, wherein a sidewall of the color filter contacts sidewalls of the plurality of dummy barrier ribs.

3. The display device of claim 2, wherein the light-shielding pattern protrudes outwardly past the dummy barrier ribs, and a thickness of the light-shielding pattern is less than a thickness of the color filter.

4. The display device of claim 2, wherein compatibility between the color filter and the light-shielding pattern is greater than compatibility between the color filter and the dummy barrier ribs.

5. A method of manufacturing a display device, the method comprising:
coating a photoresist film on a transparent insulating substrate having a light-shielding pattern thereon;
illuminating light on a rear surface of the insulating substrate and developing the photoresist film to form a plurality of dummy barrier ribs on the light-shielding pattern; and
filling in an opening area defined by the light-shielding pattern and the dummy barrier ribs with ink for forming a color filter.

6. The method of claim 5, wherein the photoresist film is a positive-type photoresist film.

7. The method of claim 5, wherein in the formation of the dummy barrier ribs, the dummy barrier ribs are formed to a smaller width than the light-shielding pattern by adjusting exposure sensitivity.

8. The method of claim 7, wherein the light-shielding pattern protrudes outwardly past the dummy barrier ribs, and a thickness of the light-shielding pattern is less than a thickness of the color filter.

9. The method of claim 5, wherein compatibility between the ink for the color filter and the light-shielding pattern is greater than compatibility between the ink for the color filter and the dummy barrier ribs.

10. The method of claim 5, wherein the ink for forming the color filter is sprayed in the opening area using an inkjet printhead.

11. The method of claim 5, wherein after the filling in of the opening area with the ink for forming the color filter, further comprising:
coating an overcoat layer on the entire surface of the resultant structure; and
forming an alignment film on the overcoat layer.

12. A method of manufacturing a display device, the method comprising:
coating a photoresist film on a transparent insulating substrate having a light-shielding pattern thereon;
illuminating light on a rear surface of the insulating substrate and developing the photoresist film to form a plurality of dummy barrier ribs on the light-shielding pattern;
filling in an opening area defined by the light-shielding pattern and the dummy barrier ribs with ink for forming a color filter; and
illuminating light on a front surface of the insulating substrate and developing the insulating substrate to remove the dummy barrier ribs.

13. The method of claim 12, wherein the photoresist film is a positive-type photoresist film.

14. The method of claim 12, wherein the ink for the color filter is a negative-type photosensitive resin composition.

15. The method of claim 12, wherein compatibility between the color filter and the light-shielding pattern is greater than compatibility between the color filter and the dummy barrier ribs.

16. The method of claim 15, wherein the light-shielding pattern protrudes outwardly past the dummy barrier ribs, and a thickness of the light-shielding pattern is less than a thickness of the color filter.

17. The method of claim 12, wherein compatibility between the ink for the color filter and the light-shielding pattern is greater than compatibility between the ink for the color filter and the dummy barrier ribs.

18. The method of claim 12, wherein the ink for forming the color filter is sprayed in the opening area using an inkjet printhead.

19. The method of claim 12, wherein after the filling in of the opening area with the ink for forming the color filter, further comprising:
coating an overcoat layer on the entire surface of the resultant structure; and
forming an alignment, film on the overcoat layer.
